(19) United States
(12) Patent Application Publication
(10) Pub. No.: US 2026/0104764 A1
(43) Pub. Date: Apr. 16, 2026

(54) EXTENDED SCREEN CONTROL METHOD AND STORAGE MEDIUM

(71) Applicant: META-BOUNDS INC., Zhuhai (CN)

(72) Inventors: Yujiang PENG, Zhuhai (CN); Peng YANG, Zhuhai (CN)

(21) Appl. No.: 19/419,160

(22) Filed: Dec. 15, 2025

Related U.S. Application Data
(63) Continuation of application No. PCT/CN2024/105007, filed on Jul. 11, 2024.

(30) Foreign Application Priority Data
Sep. 27, 2023 (CN) 2023112616598

(51) Int. Cl. G06F 3/0346

(52) U.S. Cl. CPC G06F 3/0346

(57) ABSTRACT

The present disclosure provides an extended screen control method, and a computer-readable storage medium. The method comprises: obtaining control information corresponding to the extended screen, according to a motion type of the terminal device, in which the motion type of the terminal device is determined according to motion data collected by the terminal device; and controlling the extended screen according to the control information.

### CROSS-REFERENCE TO RELATED APPLICATIONS

The application is a National Stage Application of International Application No. PCT/CN2024/105007, filed on Jul. 11, 2024, which claims the priority to Chinese Patent Application No. 2023112616598, entitled “EXTENDED SCREEN CONTROL METHOD AND APPARATUS, AND DEVICES AND STORAGE MEDIUM”, and filed on Sep. 27, 2023, the entire contents of both of which are incorporated herein by reference.

### TECHNICAL FIELD

The present disclosure relates to the technical field of intelligent terminals, and in particular, to an extended screen control method and a computer-readable storage medium.

### BACKGROUND

With the continuous development of terminal technology, which brings more and more convenience to people's daily lives, users' requirements for the screens of terminal devices are gradually increasing. Terminal devices not only include existing display screens, but extended screens of terminal devices have also become a trend in the development of terminal devices.

However, in related art, for the display screen of a terminal device, users need to control the screen display through touch. For the extended screen of a terminal device, since the extended screen is a virtual screen, users cannot control the screen display through touch. Therefore, for the extended screen of a terminal device, no corresponding method has been proposed in the related art to achieve control of the extended screen.

### SUMMARY OF THE INVENTION

The present disclosure provides a method for controlling an extended screen, applied to a wearable device, the method includes:
determining a motion type of a terminal device according to motion data collected by the terminal device;
obtaining control information corresponding to the extended screen, according to the motion type of the terminal device;
controlling the extended screen according to the control information.

The present disclosure further provides a method for controlling an extended screen, applied to a terminal device, the method includes:
obtaining motion data collected by a motion collection device in the terminal device;
determining a motion type corresponding to the terminal device according to the motion data;
sending the motion type to a wearable device, so that the wearable device determines control information corresponding to the extended screen according to the motion type, and controls the extended screen according to the control information.

The present disclosure further provides a non-transitory computer-readable storage medium, in which the computer-readable storage medium stores a computer program, and when the computer program is executed by a processor, the processor implements the method for controlling an extended screen applied to the wearable device provided by the embodiments of the present disclosure.

### BRIEF DESCRIPTION OF THE DRAWINGS

In order to more clearly illustrate the technical solutions in the embodiments of the present disclosure, the following is a brief introduction to the drawings needed in the description of the embodiments. Obviously, the drawings in the following description are some embodiments of the present disclosure. For those of ordinary skill in the art, other drawings can be obtained based on these drawings without any creative effort.

FIG. 1 is a schematic flowchart of a method for controlling an extended screen applied to a terminal device according to an embodiment of the present disclosure;

FIG. 2 is a schematic structural diagram of a terminal device according to an embodiment of the present disclosure;

FIG. 3 is a schematic diagram of an application scenario of a method for controlling an extended screen according to an embodiment of the present disclosure;

FIG. 4 is a schematic flowchart of a method for controlling an extended screen applied to a wearable device according to an embodiment of the present disclosure;

FIG. 5 is a schematic flowchart of a method for controlling an extended screen applied to a wearable device according to an another embodiment of the present disclosure;

FIG. 6 is a schematic flowchart of a method for controlling an extended screen applied to a wearable device according to an another embodiment of the present disclosure;

FIG. 7 is a schematic block diagram of an extended screen control apparatus according to an embodiment of the present disclosure;

FIG. 8 is a schematic block diagram of a wearable device according to an embodiment of the present disclosure;

FIG. 9 is a schematic block diagram of a terminal device according to an embodiment of the present disclosure.

### DETAILED DESCRIPTION OF EMBODIMENTS

The technical solutions in the embodiments of the present disclosure will be clearly and completely described below with reference to the accompanying drawings in the embodiments of the present disclosure. Obviously, the described embodiments are a part of the embodiments of the present disclosure, but not all of them. Based on the embodiments in the present disclosure, all other embodiments obtained by those of ordinary skill in the art without creative effort shall fall within the protection scope of the present disclosure.

The flowcharts shown in the drawings are for illustrative purposes only. The flowcharts do not have to include all the contents and operations/steps, nor are they required to be performed in the order described. For example, some operations/steps can be decomposed, combined, or partially merged, so the actual execution order may change according to the actual situation. In addition, although functional modules are divided in the schematic diagrams of the apparatus, in some cases, the modules can be divided differently from the modules in the apparatus schematic diagrams.

The term “and/or” used in the specification and appended claims of the present disclosure refers to any combination of one or more of the associated listed items and all possible combinations, and includes these combinations.

The following describes in detail some embodiments of the present disclosure with reference to the accompanying drawings. The embodiments and features in the embodiments may be combined with each other without conflict.

To facilitate understanding of the embodiments of the present disclosure, some backgrounds related to the embodiments of the present disclosure are briefly described below.

Currently, the size of terminal devices such as smartphones has evolved to the limit of convenient one-handed operation. The development of candy-bar phones has encountered a bottleneck, and foldable screen phones have become a potential demand and a new direction for industry development.

Taking a terminal device being a mobile phone as an example, the expansion of the physical screen display area is positively correlated with cost. The larger the display area of the mobile phone screen, the higher the cost. In the case where the process technology of foldable phones cannot achieve leapfrog development, the larger the display area required for the foldable phone screen, the larger the volume of the phone after folding, which cannot provide a good user experience. Moreover, the display area of the mobile phone screen cannot extend beyond the screen, which prevents content products based on mobile phones from achieving more information expansion and interaction expansion.

The embodiments of the present disclosure disclose an extended screen control method, an extended screen control apparatus, a terminal device, a wearable device and a computer-readable storage medium. The motion type of the terminal device is determined according to motion data collected by a motion collection device in the terminal device; the control information corresponding to the extended screen is obtained according to the motion type of the terminal device; and the extended screen is controlled according to the control information. Thereby, the extended screen of the terminal device can be controlled, in order to provide an intuitive and simple interaction method for the AR extended display of the terminal device, and improve the convenience of using the AR extended display of the terminal device.

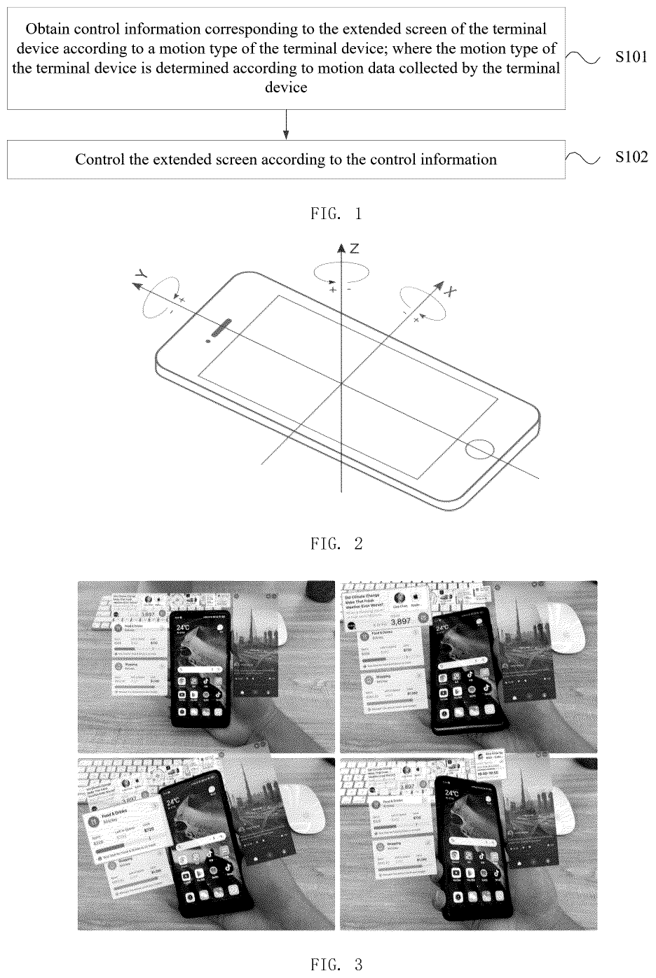

With reference to FIG. 1, FIG. 1 is a schematic flowchart of a method for controlling an extended screen according to an embodiment of the present disclosure. In this embodiment, the method for controlling the extended screen can be applied to a terminal device or a wearable device.

The terminal device can be a terminal device capable of screen display functions, such as a camera, a mobile phone, a computer, a robot, etc., which is not specifically limited herein. The wearable device can be a device such as smart glasses or an AR helmet that can be used to display the content of an AR extended screen, which is not specifically limited herein. The wearable device can be AR (Augmented Reality) glasses, VR (Virtual Reality) glasses, or any other glasses that can be used to display the content of an AR extended screen, which is not specifically limited herein.

In some embodiments, the extended screen can be a virtual extended screen projected around the terminal device through the wearable device. When a system or a third-party application within the terminal device needs to extend more display range outside the screen of the terminal device, the system/application of the terminal device sends an instruction to the client of the wearable device to invoke the AR extended screen, and simultaneously sends the content to be displayed on the AR extended screen to the client of the wearable device. After receiving the content, the client of the wearable device can display it on a specified user interface; the client of the wearable device can also display its own content on the specified user interface. It can be understood that the extended screen can display both the content of the terminal device and the content of the wearable device. The user interface of the AR extended screen is anchored to the pose of the terminal device after the wearable device identifies and tracks the position of the terminal device, becoming an extended display outside the physical screen of the terminal device.

For example, the following describes the method for controlling the extended screen provided in the embodiment of the present disclosure. The method for controlling the extended screen is applied to a wearable device and the wearable device is smart glasses. The extended screen of the terminal device is provided by the wearable device.

As shown in FIG. 1, the method for controlling the extended screen applied to the wearable device includes steps S101 to S102.

S101: Obtain control information corresponding to the extended screen of the terminal device according to a motion type of the terminal device; where the motion type of the terminal device is determined according to motion data collected by the terminal device.

The motion collection device can be a data collection device that collects motion data of the terminal device, such as a gyroscope or an accelerometer. The motion data can include data such as angular velocity and acceleration. The motion type can include left/right jog (around the z-axis), left/right jog (around the y-axis), up/down jog (around the x-axis), tap, etc. Specifically, both jog and tap can be defined as single, double, or multiple times. The control information can be used to control the screen content of the extended screen. For example, it can control the icon pre-selection cursor on the extended screen to jump to the icon to the left of the current icon; it can also be used to select an icon, activate an icon, close an icon, or switch icons, etc. The icon can be a virtual program on the extended screen of the terminal device. The number of extended screens of the terminal device can be set according to specific needs. For example, the number of extended screens can be one or more, and the size of each extended screen can be the same or different.

It should be noted that the steps corresponding to “determining the motion type corresponding to the terminal device according to the motion data” and “determining the control information corresponding to the extended screen of the terminal device according to the motion type” can be implemented on the terminal device or on the wearable device, which is not specifically limited herein.

S102: Control the extended screen according to the control information.

Specifically, the wearable device, such as smart glasses, can control the extended screen to display corresponding screen content according to the control information.

In some embodiments, if the control information is used to control the extended screen to perform a selection action, the smart glasses can display the screen content corresponding to the selection action on the extended screen according to the control information. For example, when the content displayed on the extended screen is a photo album, the selection action can be selecting one of the photos.

The method for controlling the extended screen provided by the embodiments of the present disclosure includes: determining the motion type of the terminal device according to the motion data collected by the motion collection device in the terminal device; obtaining control information corresponding to the extended screen according to the motion type of the terminal device; and controlling the extended screen according to the control information. Thereby, the extended screen of the terminal device can be controlled, in order to provide an intuitive and simple interaction method for the AR extended display of the terminal device, and improve the convenience of using the AR extended display of the terminal device.

The following takes the wearable device being smart glasses and the terminal device being a mobile phone as an example for description.

In the embodiments of the present disclosure, when a user operates the terminal device, the terminal device can detect a change in the device state and can collect motion data corresponding to the motion of the terminal device through the motion collection device of the terminal device, which can accurately collect the corresponding motion data.

In some embodiments, if the user operates the terminal device to inch left/right (around the z-axis), the gyroscope of the terminal device can collect the angular velocity data corresponding to the motion of the terminal device, which can accurately collect the corresponding angular velocity data. That is, the angular velocity data can be used to detect a change in the device state of the terminal device. The device state can include the state of the terminal device reflected by events such as jog or tap of the terminal device.

In some embodiments, if the user taps the terminal device, the accelerometer of the terminal device can collect the acceleration data corresponding to the motion of the terminal device, which can accurately collect the corresponding acceleration data. At this time, the acceleration data can be used to determine whether the device state of the terminal device has changed.

As shown in FIG. 2, in some embodiments, taking the terminal device as a mobile phone as an example, the user can control the mobile phone to inch left/right (around the z-axis), control the mobile phone to inch left/right (around the y-axis), control the mobile phone to inch up/down (around the x-axis), or tap the mobile phone. Each of these user operations corresponds to a motion type.

In some embodiments, a data type is determined according to the motion data; and the motion data is calculated according to the data type to obtain the motion type corresponding to the terminal device. The embodiments of the present disclosure can accurately determine the data type and can calculate the motion type corresponding to the terminal device specifically and accurately according to the data type.

The data type can include types such as angular velocity data and acceleration data.

In some embodiments, the data type can be determined by detecting the type of the motion collection device. For example, when the motion data is obtained from a gyroscope, the data type of the motion data can be determined as angular velocity data; when the motion data is obtained from an accelerometer, the data type of the motion data can be determined as acceleration data.

In some embodiments, the data type can also be determined by detecting data characteristics such as numerical features or change curves of the data, which is not specifically limited herein.

In some embodiments, when the data type is angular velocity data, a rotation angle of the terminal device is determined through the angular velocity data, and the motion type corresponding to the terminal device is determined according to the rotation angle; when the data type is acceleration data, an acceleration slope corresponding to the acceleration data is determined, and the motion type corresponding to the terminal device is determined according to the acceleration slope. The embodiments of the present disclosure can use corresponding algorithms to calculate the obtained data according to different data types, which can accurately calculate the motion type corresponding to the terminal device.

The rotation angle of the terminal device is the angle at which the terminal device rotates in a certain direction over a period of time; the acceleration slope can be the slope between two consecutive acceleration samples.

In some embodiments, when the data type is angular velocity data, the angular velocity data is used to calculate the rotation angles of the terminal device in a rotation phase and a return phase, and the jog type corresponding to the terminal device is determined according to the rotation angles of the rotation phase and the return phase.

The rotation phase is the process in which the terminal device rotates toward a first direction; the return phase is the process in which the terminal device rotates toward the opposite direction of the first direction. The first direction can be any direction, such as left, right, up, down, etc.

In some embodiments, when the data type is acceleration data, an acceleration slope corresponding to two consecutive acceleration data is determined, and the tap type corresponding to the terminal device is determined according to the acceleration slope.

It should be noted that the angular velocity data and the acceleration data can be collected simultaneously by the motion collection device in the terminal device, and the angular velocity data and the acceleration data can be calculated specifically at the same time, which is not specifically limited herein.

Therefore, the present disclosure can determine that the data type includes angular velocity data and/or acceleration data by analyzing the motion data; for angular velocity data and acceleration data, the present disclosure proposes corresponding algorithms to calculate the angular velocity data and acceleration data, which can determine the motion type corresponding to the terminal device.

The following takes the wearable device being smart glasses, the terminal device being a mobile phone, and the motion data collected by the motion collection device being angular velocity data as an example for description.

In some embodiments, angular velocity data corresponding to a first time period is obtained, and the angular velocity data includes an angular velocity component and an angular velocity modulus value; when the angular velocity component and/or the angular velocity modulus value corresponding to the first time period exceeds a respective predetermined angular velocity threshold, the angular velocity component and/or the angular velocity modulus value corresponding to the first time period is processed to obtain a first rotation angle; when the first rotation angle is within a predetermined angle range, an angular velocity component corresponding to a second time period is obtained, and the angular velocity component corresponding to the second time period is processed to obtain a second rotation angle; the motion type corresponding to the terminal device is determined according to the first rotation angle and the second rotation angle. The embodiments of the present disclosure can accurately determine the first rotation angle and the second rotation angle, which can accurately determine the motion type corresponding to the terminal device based on the first rotation angle and the second rotation angle.

The angular velocity data includes an angular velocity component and an angular velocity modulus value. The angular velocity component can include three-axis angular velocity components, i. e., the angular velocity components corresponding to the x-axis, y-axis, and z-axis; the angular velocity modulus value can be an absolute value calculated from the three-axis angular velocity components. The predetermined angular velocity threshold can be any angular velocity value, specifically set by the user, which is not limited herein. The first time period is the time period corresponding to the rotation phase of the terminal device, and the second time period is the time period corresponding to the return phase of the terminal device. The first rotation angle can be the angle by which the terminal device rotates during the first time period, and the second rotation angle can be the angle by which the terminal device rotates during the second time period. The predetermined angle range can be any angle, specifically set by the user, which is not limited herein.

It should be noted that each angular velocity component and the angular velocity modulus value has its corresponding predetermined angular velocity threshold. When any angular velocity component or the angular velocity modulus value exceeds its corresponding predetermined angular velocity threshold, the angular velocity component and/or the angular velocity modulus value that exceeds its corresponding predetermined angular velocity threshold can be processed to obtain the first rotation angle.

In some embodiments, when the angular velocity component corresponding to the x-axis exceeds its corresponding predetermined angular velocity threshold, it can be determined to process the angular velocity component corresponding to the x-axis to obtain the first rotation angle.

In the embodiments of the present disclosure, the three-axis angular velocity components obtained through the gyroscope, namely (ωₓ, ω_{y}, ω_{z}), can be used to calculate the corresponding angular velocity modulus value.

In some embodiments, the formula for calculating the angular velocity modulus value can be:

$$\vert ω \vert = \sqrt{{( {ω}_{x} )}^{2} + {( {ω}_{y} )}^{2} + {( {ω}_{z} )}^{2}} ;$$

where |ω| is the angular velocity modulus value, ωₓ is the angular velocity component corresponding to the x-axis, ω_{y} is the angular velocity component corresponding to the y-axis, and ω_{z} is the angular velocity component corresponding to the z-axis.

When the angular velocity component and/or the angular velocity modulus value corresponding to the first time period exceeds the respective predetermined angular velocity threshold, the specific motion axis of the gyroscope is identified, and Euler integration is performed on the angular velocity component corresponding to the motion axis within the first time period to obtain the first rotation angle; when the angular velocity component and the angular velocity modulus value corresponding to the first time period do not exceed the predetermined angular velocity threshold, it is determined that the terminal device did not undergo a rotation phase.

The motion axis can be the axis on which the gyroscope detects that the terminal device is moving.

In some embodiments, when the predetermined angular velocity threshold is 5°/s, and ωₓ is 10°, ω_{y} is 0°, ω_{z} is 0°, then the angular velocity modulus value is also 10°. It can be determined that the angular velocity component and the angular velocity modulus value corresponding to the first time period exceed the predetermined angular velocity threshold, and the specific motion axis of the gyroscope is identified as the x-axis. Euler integration is performed on the angular velocity component corresponding to the x-axis within the first time period to obtain the first rotation angle.

It should be noted that when the gyroscope identifies multiple specific motion axes, such as the x-axis and y-axis, then Euler integration needs to be performed on the angular velocity components corresponding to the x-axis and y-axis within the first time period respectively to obtain the first rotation angles corresponding to the x-axis and y-axis.

Specifically, the formula for calculating the rotation angle can be expressed as:

$$θ = {\int }_{{t}_{1}}^{{t}_{2}} ω ( t ) * dt ;$$

where θ is the rotation angle within the time period, which can be the first rotation angle or the second rotation angle; t₁ is the start time of rotation around the calculated axis, t₂ is the end time of rotation around the calculated axis; ω(t) is the angular velocity component corresponding to the motion axis at time t.

When the first rotation angle is within the predetermined angle range, the angular velocity component corresponding to the second time period is obtained, and Euler integration is performed on the angular velocity component corresponding to the second time period to obtain the second rotation angle. When the first rotation angle is not within the predetermined angle range, it can be determined that the terminal device did not undergo a return phase.

In some embodiments, when the predetermined angle range is from 15° to 45° and the first rotation angle is 30°, it can be determined that the first rotation angle is within the predetermined angle range. The angular velocity component corresponding to the second time period is obtained, and Euler integration is performed on the angular velocity component corresponding to the second time period to obtain the second rotation angle.

In some embodiments, after obtaining the first rotation angle, a first angular velocity component and a second angular velocity component within the first time period are obtained; an angular velocity slope is determined according to the first angular velocity component and its corresponding timestamp information, and the second angular velocity component and its corresponding timestamp information; when the first rotation angle is within the predetermined angle range and the angular velocity slope is greater than a predetermined angular velocity slope, the angular velocity component corresponding to the second time period is obtained, and the angular velocity component corresponding to the second time period is processed to obtain the second rotation angle. The embodiments of the present disclosure can accurately calculate the second rotation angle using the angular velocity components.

The first angular velocity component and the second angular velocity component can be two consecutive angular velocity components within the first time period; the timestamp information is used to record the timestamps corresponding to the first and second angular velocity components; the angular velocity slope can be the slope between two consecutive angular velocity samples. The predetermined angular velocity slope can be any angular velocity slope, which can be set according to actual situations, and is not limited herein.

Specifically, the angular velocity slope is determined according to the first angular velocity component and its corresponding timestamp information, and the second angular velocity component and its corresponding timestamp information; when the first rotation angle is within the predetermined angle range and the angular velocity slope is greater than the predetermined angular velocity slope, the angular velocity component corresponding to the second time period is obtained, and the angular velocity component corresponding to the second time period is processed to obtain the second rotation angle; when the first rotation angle is not within the predetermined angle range or the angular velocity slope is not greater than the predetermined angular velocity slope, it can be determined that the terminal device did not undergo a return phase.

In some embodiments, the formula for calculating the angular velocity slope can be expressed as:

$$slope ω ( t ) = \frac{{ω}_{3} - {ω}_{4}}{{t}_{3} - {t}_{4}} ;$$

where slope ω(t) is the angular velocity slope, ω₃ is the first angular velocity component, ω₄ is the second angular velocity component, t₃ is the timestamp information corresponding to the first angular velocity component, and ta is the timestamp information corresponding to the second angular velocity component.

In some embodiments, a difference between the first rotation angle and the second rotation angle is determined; when the difference between the first rotation angle and the second rotation angle is less than a predetermined angle threshold, it is determined that the motion type corresponding to the terminal device is a jog type. The embodiments of the present disclosure can accurately determine the motion type corresponding to the terminal device by comparing the first rotation angle and the second rotation angle.

The predetermined angle threshold can be any angle, specifically determined by the actual situation, and is not limited herein.

It should be noted that after determining that the motion type corresponding to the terminal device is a jog type, the specific jog type can be determined by reading the motion axis and the motion direction from the gyroscope. For example, when the motion axis read by the gyroscope is the x-axis and the motion direction is clockwise (e. g., detecting a positive acceleration value), it can be considered that the motion type corresponding to the terminal device is a right jog around the x-axis. The motion axis can also be determined by the angular velocity component and its corresponding predetermined angular velocity threshold. When the angular velocity component corresponding to the x-axis exceeds its corresponding predetermined angular velocity threshold, it can be considered that the motion axis includes the x-axis.

In some embodiments, the difference between the first rotation angle and the second rotation angle is determined; when the difference is less than the predetermined angle threshold, it is determined that the motion type corresponding to the terminal device is a jog type; when the difference is greater than or equal to the predetermined angle threshold, it is determined that the motion type corresponding to the terminal device is not a jog type.

In some embodiments, when the first rotation angle is 30°, the second rotation angle is 20°, and the predetermined angle threshold is 20°, the difference between the first rotation angle and the second rotation angle is determined to be 10°; and since the difference is less than the predetermined angle threshold, it is determined that the motion type corresponding to the terminal device is a jog type.

The above uses the example where the motion data collected by the motion collection device is angular velocity data to explain how to determine the motion type corresponding to the terminal device.

The following takes the wearable device being smart glasses, the terminal device being a mobile phone, and the motion data collected by the motion collection device being acceleration data as an example for description.

In some embodiments, acceleration data corresponding to a plurality of moments is obtained, the acceleration data including an acceleration component and an acceleration modulus value; when an acceleration component and/or an acceleration modulus value corresponding to a first moment exceeds a respective predetermined acceleration threshold, the acceleration component and/or the acceleration modulus value corresponding to the first moment and an adjacent moment is processed to obtain a first acceleration slope; when the first acceleration slope exceeds a predetermined slope threshold, it is determined that the motion type corresponding to the terminal device is a single tap. The embodiments of the present disclosure can accurately determine that the motion type corresponding to the terminal device is a single tap according to the acceleration data.

The acceleration data includes an acceleration component and an acceleration modulus value. The acceleration component can include three-axis acceleration components, i. e., the acceleration components corresponding to the x-axis, y-axis, and z-axis; the acceleration modulus value can be an absolute value calculated from the three-axis acceleration components. The predetermined acceleration threshold can be any acceleration value, specifically set by the user, which is not limited herein. The first moment and its adjacent moment can be two consecutive moments among the plurality of moments; the first acceleration slope is the acceleration slope corresponding to the first moment and its adjacent moment; the predetermined slope threshold can be any acceleration slope value, specifically set by the user, which is not limited herein.

It should be noted that each acceleration component and the acceleration modulus value has its corresponding predetermined acceleration threshold. When any acceleration component or the acceleration modulus value in the first moment exceeds its corresponding predetermined the acceleration threshold, acceleration component and/or the acceleration modulus value corresponding to the first moment and its adjacent moment can be processed to obtain the first acceleration slope.

In some embodiments, when the acceleration component corresponding to the x-axis in the first moment exceeds its corresponding predetermined acceleration threshold, the acceleration component corresponding to the x-axis in the first moment and the second moment (adjacent moment) can be processed to obtain the first acceleration slope.

In the embodiments of the present disclosure, the three-axis acceleration components obtained through the accelerometer, namely (aₓ, a_{y}, a_{z}), can be used to calculate the corresponding acceleration modulus value.

In some embodiments, the formula for calculating the acceleration modulus value can be:

$$\vert a \vert = \sqrt{{( {a}_{x} )}^{2} + {( {a}_{y} )}^{2} + {( {a}_{z} )}^{2}} ;$$

where |a| is the acceleration modulus value, aₓ is the acceleration component corresponding to the x-axis, a_{y} is the acceleration component corresponding to the y-axis, and a_{z} is the acceleration component corresponding to the z-axis.

When the acceleration component and/or the acceleration modulus value corresponding to the first moment exceeds the respective predetermined acceleration threshold, the acceleration component and/or the acceleration modulus value corresponding to the first moment and the second moment (adjacent moment) is processed to obtain the first acceleration slope; when the acceleration component and the acceleration modulus value corresponding to the first moment do not exceed the predetermined acceleration threshold, it is determined that the terminal device has not detected a tap.

In some embodiments, when the predetermined acceleration threshold is 1 m/s², and ωₓ is 2 m/s², ω_{y} is 0 m/s², ω_{z} is 0 m/s², then the acceleration modulus value is also 2 m/s². It can be determined that the acceleration component and the acceleration modulus value corresponding to the first time period exceed the predetermined acceleration threshold, and the slope between two consecutive acceleration samples is calculated to obtain the first acceleration slope.

It should be noted that when the accelerometer detects that acceleration components corresponding to multiple axes exceed the predetermined acceleration threshold, such as the x-axis and the y-axis, then the slope calculation needs to be performed separately on the acceleration components corresponding to the x-axis and the y-axis at the first moment, to obtain the first acceleration slopes corresponding to the x-axis and the y-axis.

Specifically, the formula for calculating the acceleration slope can be expressed as:

$$slope ( {t}_{n} ) = \frac{a ( {t}_{n} ) - a ( {t}_{( n - 1 )} )}{{t}_{n} - {t}_{( n - 1 )}} ;$$

where slope (tₙ) is the slope between two consecutive acceleration samples; tₙ and t₍ₙ₋₁₎ are the times of the two consecutive acceleration samples, respectively; a(tₙ) is the acceleration of the calculated axis at time tₙ.

In some embodiments, it is determined whether the first acceleration slope exceeds a predetermined slope threshold. When the first acceleration slope exceeds the predetermined slope threshold, it is determined that the motion type corresponding to the terminal device is a single tap; when the first acceleration slope does not exceed the predetermined slope threshold, it is determined that the terminal device did not detect a tap.

In some embodiments, after determining that the motion type corresponding to the terminal device is a single tap, it is determined whether an acceleration component and an acceleration modulus value corresponding to a second moment exceeds the respective predetermined acceleration threshold; when the acceleration component and/or the acceleration modulus value corresponding to the second moment exceeds the respective predetermined acceleration threshold, the acceleration component and/or the acceleration modulus value corresponding to the second moment and its adjacent moment is processed to obtain a second acceleration slope; when the second acceleration slope exceeds the predetermined slope threshold, a difference between the second moment and the first moment is determined; when the difference between the second moment and the first moment is less than a predetermined time threshold, it is determined that the motion type corresponding to the terminal device is a multiple tap. The embodiments of the present disclosure can accurately determine whether the motion type corresponding to the terminal device is a multiple tap, which can accurately determine the motion type corresponding to the terminal device.

The second moment and its adjacent moment can be two consecutive moments among the plurality of moments, and the time of the second moment is later than the time of the first moment. The second acceleration slope is the acceleration slope corresponding to the second moment and its adjacent moment. The predetermined time threshold can be any time value, such as 5 seconds, which is not specifically limited herein.

Specifically, when it is determined that the second acceleration slope exceeds the predetermined slope threshold, the difference between the second moment and the first moment is determined; when the difference between the second moment and the first moment is less than the predetermined time threshold, it is determined that the motion type corresponding to the terminal device is a multiple tap; when the difference between the second moment and the first moment is not less than the predetermined time threshold, it is determined that the motion type corresponding to the terminal device is a single tap.

In some embodiments, when the first moment is 15:10:05, the second moment is 15:10:12, and the predetermined time threshold is 10 seconds, the difference between the second moment and the first moment is determined to be 7 seconds. It can be determined that the difference between the second moment and the first moment is less than the predetermined time threshold, which can determine that the motion type corresponding to the terminal device is a multiple tap.

The above uses the example where the motion data collected by the motion collection device is acceleration data to explain how to determine the motion type corresponding to the terminal device.

It should be noted that the above embodiments all explain how to determine the motion type corresponding to the terminal device. These embodiments can be executed individually or simultaneously.

In some embodiments, a mapping relationship between a predetermined motion type and control information is obtained, and it is determined whether the motion type of the terminal device is the predetermined motion type; when the motion type of the terminal device is the predetermined motion type, control information corresponding to the motion type of the terminal device is determined according to the mapping relationship. The embodiments of the present disclosure can accurately determine the corresponding control information according to the motion type, so as to display the corresponding screen content on the extended screen.

The mapping relationship between the predetermined motion type and the control information is used to represent the corresponding relationship between each predetermined control information and each 1 content. The predetermined motion type can include left jog around the x-axis, left jog around the y-axis, tap, etc. The control information can be used to control the screen content of the extended screen. The icon can be a virtual icon on the extended screen of the terminal device.

In some embodiments, when it is determined that the motion type of the terminal device is a left jog around the x-axis, it can be determined whether the motion type of the terminal device is a predetermined motion type; when it is determined that the motion type of the terminal device is a predetermined motion type, then according to the mapping relationship between the predetermined motion type and the control information, the control information corresponding to the left jog around the x-axis is determined, for example, the control information is used to control the extended screen to perform a selection action.

In some embodiments, the control information includes at least one of the following: controlling the extended screen to execute an activation instruction; controlling the extended screen to execute a selection instruction; controlling the extended screen to execute a deactivation instruction; controlling the extended screen to execute a switch instruction; controlling the extended screen to execute a zoom-in instruction; and controlling the extended screen to execute a zoom-out instruction.

The control instruction for controlling the extended screen to execute an activation instruction is used to instruct the extended screen to display the screen content corresponding to the activated icon or the activated page; the control instruction for controlling the extended screen to execute a selection instruction is used to instruct the extended screen to display the screen content corresponding to the selected icon or the selected page; the control instruction for controlling the extended screen to execute a deactivation instruction is used to instruct the extended screen to deactivate the screen content corresponding to the deactivated icon or the deactivated page; the control instruction for controlling the extended screen to execute a switch instruction is used to instruct the extended screen to display the screen content corresponding to the switched icon or the switched page; the control instruction for controlling the extended screen to execute a zoom-in instruction is used to instruct the extended screen to display the screen content corresponding to the zoomed-in icon or the zoomed-in page; the control instruction for controlling the extended screen to execute a zoom-out instruction is used to instruct the extended screen to display the screen content corresponding to the zoomed-out icon or the zoomed-out page. The icon can be an icon corresponding to an application program displayed on the extended screen. For example, when the WeChat application is displayed on the extended screen, the icon is the WeChat icon, and this icon can be used to distinguish different application programs; the icon can also be an icon of related content displayed on the extended screen, through which page switching can be performed or certain content can be selected.

In some embodiments, the control information corresponds to a predetermined motion type. For example, the instruction to control the extended screen to open a corresponding icon corresponds to a left jog around the x-axis; the instruction to control the extended screen to close a corresponding icon corresponds to a single tap, etc. Specifically, the mapping relationship between the predetermined motion type and the control information can be set according to the actual situation, which is not limited herein.

As shown in FIG. 3, in some embodiments, the screen content of the extended screen can include selection actions, cancellation actions, moving the cursor up, down, left, and right, etc. The extended screen can be displayed in the space on the left side, the right side, and the top of the terminal device.

In some embodiments, the upward/downward jog (around the x-axis) and the left/right jog (around the z-axis) of the terminal device can be set in advance to be associated with moving the cursor up, down, left, and right respectively. When a left jog is performed, due to the slight movement, the position of the extended screen content does not change, only the cursor moves left to the icon to the left of the current cursor position. For example, if a single tap and a double tap are associated with selection and cancellation respectively, then when a single tap is detected, the content of the icon where the cursor is located can be selected.

In some embodiments, taking the terminal device as a mobile phone as an example, the actions of holding the mobile phone and the actions of the extended screen content can be defined by the user. For example, gently shaking the mobile phone screen (equivalent to continuous left and right jogs around the x-axis) is associated with a multi-component selection action; gently lifting the top of the mobile phone (equivalent to a left jog around the z-axis) is associated with a confirmation action & open action; gently lifting the left side of the mobile phone (equivalent to a left jog around the x-axis) is associated with a return action & close action; gently lifting the right side of the mobile phone (equivalent to a right jog around the x-axis) is associated with a switch action, etc. Specifically, the user can set it in advance and store the corresponding mapping relationship in the wearable device or the terminal device.

In some embodiments, taking the terminal device as a mobile phone as an example, after the extended screen displays the corresponding screen content, when the extended screen tilts with the gravity sensing angle of the mobile phone (i. e., the amplitude of the flick type) changes, the extended screen can also present effects such as zoom-in and transparency gradient; or after selecting the extended screen confirmation operation, the extended screen can also present a zoom-in effect on component to display more detailed content; or when closing & exiting the current component, the extended screen can also present a zoom-out effect on component and return to the original extended display area; or when switching the extended screen, the extended screen can also present effects such as dynamic gradual zoom-in or zoom-out. Specifically, this can be achieved by setting the mapping relationship between the tilt angle of the mobile phone and the control information.

In some embodiments, the following uses the example where the method for controlling the extended screen is applied to the terminal device to describe the method for controlling the extended screen provided by the embodiments of the present disclosure. The extended screen of the terminal device is provided by the wearable device.

As shown in FIG. 4, the method for controlling the extended screen applied to the terminal device includes steps S201 to S203.

S201: Obtain motion data collected by a motion collection device in the terminal device.

S202: Determine a motion type corresponding to the terminal device according to the motion data.

S203: Send the motion type to a wearable device, so that the wearable device determines control information corresponding to the extended screen according to the motion type, and controls the extended screen according to the control information.

It can be understood that the steps corresponding to “determining the motion type corresponding to the terminal device according to the motion data” and “determining the control information corresponding to the extended screen of the terminal device according to the motion type” can be implemented on the terminal device or on the wearable device. The specific embodiments corresponding to the above steps have been described above and will not be repeated here.

The method for controlling the extended screen provided by the embodiments of the present disclosure includes: obtain motion data collected by a motion collection device in the terminal device; determine a motion type corresponding to the terminal device according to the motion data; send the motion type to a wearable device, so that the wearable device determines control information corresponding to the extended screen according to the motion type, and controls the extended screen according to the control information. Thereby, the step of “determining a motion type corresponding to the terminal device according to the motion data” can be implemented on the terminal device and the step of “determining control information corresponding to the extended screen of the terminal device according to the motion type” can be implemented on the wearable device, so as to balance the computational data volume of the terminal device and the wearable device, thereby achieving control of the extended screen of the terminal device, providing an intuitive and simple interaction method for the AR extended display of the terminal device, and improving the convenience of using the AR extended display of the terminal device.

The following will demonstrate the method for controlling the extended screen in various application scenarios.

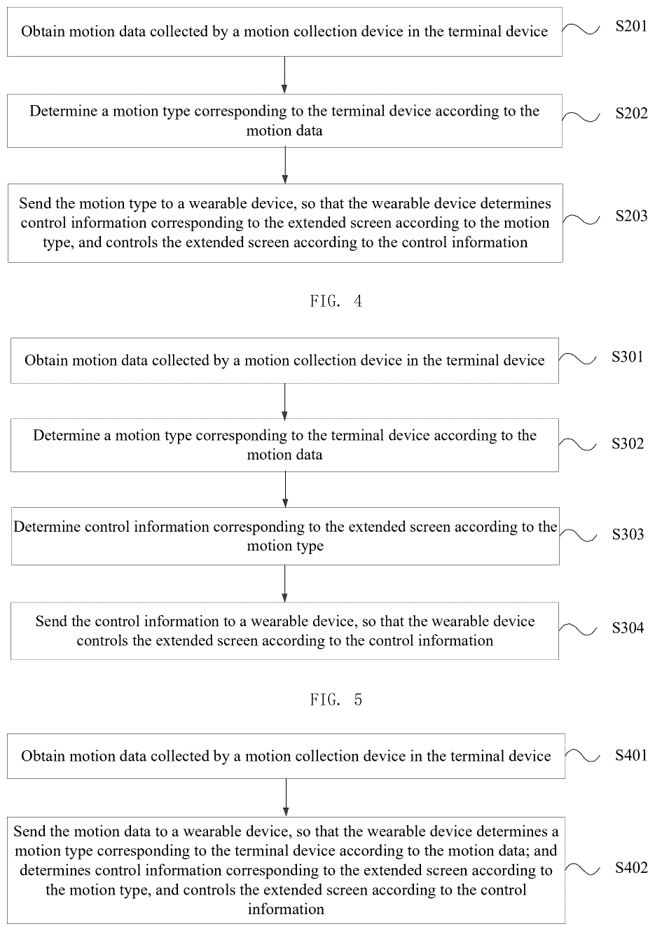

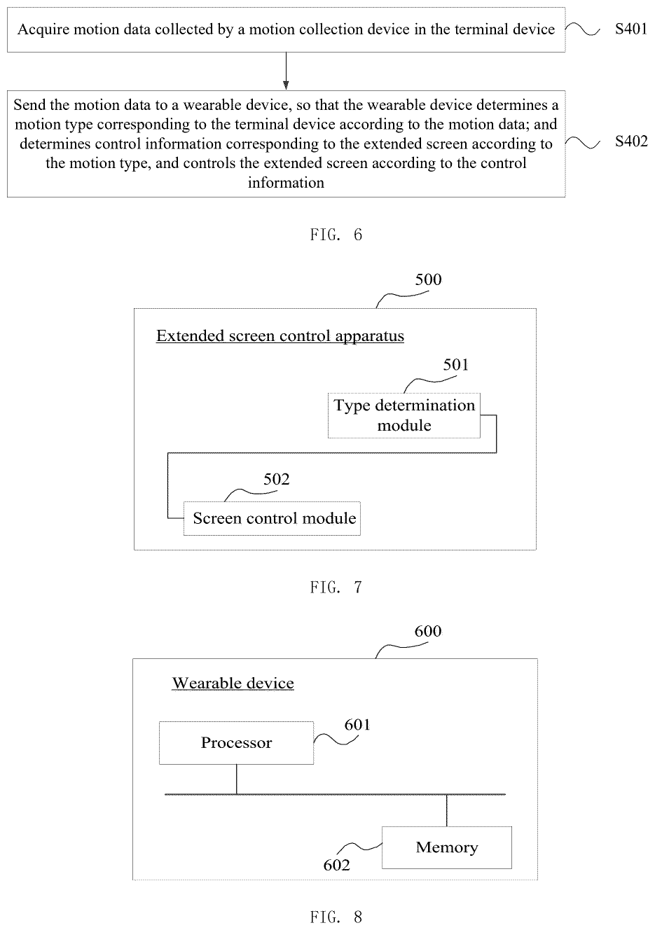

With reference to FIG. 5, FIG. 5 is a schematic flowchart of a method for controlling an extended screen according to an another embodiment of the present disclosure.

As shown in FIG. 5, the method for controlling the extended screen applied to the terminal device includes steps S301 to S304.

S301: Obtain motion data collected by a motion collection device in the terminal device.

S302: Determine a motion type corresponding to the terminal device according to the motion data.

S303: Determine control information corresponding to the extended screen according to the motion type.

S304: Send the control information to a wearable device, so that the wearable device controls the extended screen according to the control information.

The method for controlling the extended screen provided by the embodiments of the present disclosure includes: obtaining motion data collected by a motion collection device in the terminal device; determining a motion type corresponding to the terminal device according to the motion data; determining control information corresponding to the extended screen of the terminal device according to the motion type; sending the control information to a wearable device, so that the wearable device controls the extended screen according to the control information. Thereby, steps such as “determining a motion type corresponding to the terminal device according to the motion data” and “determining control information corresponding to the extended screen of the terminal device according to the motion type” can be implemented on the terminal device, reducing the computational data volume of the wearable device and alleviating the computational burden of the wearable device. The extended screen of the terminal device can be controlled, which provides an intuitive and simple interaction method for the AR extended display of the terminal device, and improves the convenience of using the AR extended display of the terminal device.

With reference to FIG. 6, FIG. 6 is a schematic flowchart of a method for controlling an extended screen according to an another embodiment of the present disclosure.

As shown in FIG. 6, the method for controlling the extended screen applied to the terminal device includes steps S401 to S402.

S401: Obtain motion data collected by a motion collection device in the terminal device.

S402: Send the motion data to a wearable device, so that the wearable device determines a motion type corresponding to the terminal device according to the motion data; and determine control information corresponding to the extended screen according to the motion type, and control the extended screen according to the control information.

It should be noted that the specific embodiments corresponding to the steps of “determining a motion type corresponding to the terminal device according to the motion data” and “determining control information corresponding to the extended screen of the terminal device according to the motion type” have been described above and will not be repeated here.

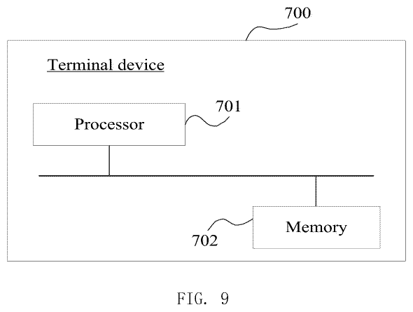

With reference to FIG. 7, FIG. 7 is a schematic block diagram of an extended screen control apparatus according to an embodiment of the present disclosure. As shown in FIG. 7, the extended screen control apparatus 500 includes: a type determination module 501 and a screen control module 502.

The type determination module 501 is configured to obtain control information corresponding to the extended screen according to a motion type of the terminal device; where the motion type of the terminal device is determined according to motion data collected by the terminal device.

The screen control module 502 is configured to control the extended screen according to the control information.

It should be noted that those skilled in the art can clearly understand that, for the convenience and brevity of description, the specific working processes of the above-described apparatus and each module and unit can refer to the corresponding processes in the foregoing method embodiments, and will not be repeated here.

The methods and apparatus of the present disclosure can be used in many general or specialized computing system environments or configurations. For example: personal computers, server computers, handheld devices or portable devices, tablet devices, multi-processor systems, microprocessor-based systems, set-top boxes, programmable consumer terminal devices, network PCs, small computers, mainframe computers, distributed computing environments including any of the above systems or devices, etc.

With reference to FIG. 8, FIG. 8 is a schematic structural block diagram of a wearable device 600 according to an embodiment of the present disclosure.

As shown in FIG. 8, the wearable device 600 may include a processor 601 and a memory 602. The processor 601 and the memory 602 are connected via a bus 603, which is, for example, an I2C (Inter-integrated Circuit) bus.

In some embodiments, the processor 601 can be used to provide computing and control capabilities to support the operation of the entire terminal device. The processor 601 may be a Central Processing Unit (CPU). The processor 601 may also be other general-purpose processors, Digital Signal Processor (DSP), Application Specific Integrated Circuit (ASIC), Field-Programmable Gate Array (FPGA) or other programmable logic devices, discrete gate or transistor logic devices, discrete hardware components, etc. Among them, the general-purpose processor may be a microprocessor, or the processor may also be any conventional processor, etc.

Specifically, the memory 602 may be a Flash chip, a Read-Only Memory (ROM), a magnetic disk, an optical disk, a U disk, or a mobile hard disk, etc.

Those skilled in the art can understand that the structure shown in FIG. 8 is a block diagram of a part of the structure related to the solution of the embodiments of the present disclosure, and does not constitute a limitation on the terminal device to which the solution of the embodiments of the present disclosure is applied. The specific server may include more or fewer components than shown in the figure, or combine some components, or have different component arrangements.

The processor 601 is configured to run a computer program stored in the memory and, when executing the computer program, implement any method for controlling an extended screen applied to a wearable device provided by the embodiments of the present disclosure.

In one embodiment, the processor 601 is configured to run a computer program stored in the memory. When the computer program is executed, the processor 601 can implement the following steps: obtaining control information corresponding to the extended screen according to a motion type of the terminal device, where the motion type of the terminal device is determined according to motion data collected by the terminal device; controlling the extended screen according to the control information.

It should be noted that those skilled in the art can clearly understand that, for the convenience and brevity of description, the specific working process of the above-described wearable device can refer to the corresponding process in the foregoing method embodiments, and will not be repeated here.

With reference to FIG. 9, FIG. 9 is a schematic structural block diagram of a terminal device 700 according to an embodiment of the present disclosure.

As shown in FIG. 9, the terminal device 700 may include a processor 701 and a memory 702. The processor 701 and the memory 702 are connected via a bus 703, which is, for example, an I2C (Inter-integrated Circuit) bus.

In some embodiments, the processor 701 can be used to provide computing and control capabilities to support the operation of the entire terminal device. The processor 701 may be a Central Processing Unit (CPU). The processor 701 may also be other general-purpose processors, Digital Signal Processor (DSP), Application Specific Integrated Circuit (ASIC), Field-Programmable Gate Array (FPGA) or other programmable logic devices, discrete gate or transistor logic devices, discrete hardware components, etc. Among them, the general-purpose processor may be a microprocessor, or the processor may also be any conventional processor, etc.

Specifically, the memory 702 may be a Flash chip, a Read-Only Memory (ROM), a magnetic disk, an optical disk, a U disk, or a mobile hard disk, etc.

Those skilled in the art can understand that the structure shown in FIG. 9 is a block diagram of a part of the structure related to the solution of the embodiments of the present disclosure, and does not constitute a limitation on the terminal device to which the solution of the embodiments of the present disclosure is applied. The specific server may include more or fewer components than shown in the figure, or combine some components, or have different component arrangements.

The processor 701 is configured to run a computer program stored in the memory and, when executing the computer program, implement any method for controlling an extended screen applied to a terminal device provided by the embodiments of the present disclosure.

In one embodiment, the processor 701 is configured to run a computer program stored in the memory. Whenthe computer program is executed, the processor 701 can implement the following steps: obtaining motion data collected by a motion collection device in the terminal device; determining a motion type corresponding to the terminal device according to the motion data; sending the motion type to a wearable device, so that the wearable device determines control information corresponding to the extended screen according to the motion type, and controls the extended screen according to the control information.

It should be noted that those skilled in the art can clearly understand that, for the convenience and brevity of description, the specific working process of the above-described terminal device can refer to the corresponding process in the foregoing method embodiments, and will not be repeated here.

The embodiments of the present disclosure also provide a computer-readable storage medium. The computer-readable storage medium stores a computer program. The computer program includes program instructions. When the program instructions are executed, any method for controlling an extended screen applied to a terminal device or a method for controlling an extended screen applied to a wearable device provided by the embodiments of the present disclosure is implemented.

The computer-readable storage medium may be the internal storage unit of the wearable device described in the foregoing embodiments, such as the memory of the wearable device. The computer-readable storage medium may also be an external storage device of the wearable device, such as a plug-in hard disk, a Smart Media Card (SMC), a Secure Digital (SD) card, a Flash Card, etc, which are equipped on the wearable device.

In some embodiment, the computer-readable storage medium may mainly include a storage program area and a storage data area. The storage program area may store an operating system, application programs required for at least one function, etc.

The above descriptions are specific embodiments of the present disclosure, but the protection scope of the present disclosure is not limited thereto. Any person skilled in the art can easily think of various equivalent modifications or substitutions within the technical scope disclosed in the present disclosure, and these modifications or substitutions shall fall within the protection scope of the present disclosure. Therefore, the protection scope of the present disclosure shall be subject to the protection scope of the claims.

What is claimed is:

1. A method for controlling an extended screen, applied to a wearable device, the method comprising:
determining a motion type of a terminal device according to motion data collected by the terminal device;
obtaining control information corresponding to the extended screen, according to the motion type of the terminal device;
controlling the extended screen according to the control information.

2. The method according to claim 1, wherein the determining a motion type of a terminal device according to motion data collected by the terminal device comprises:
determining a data type according to the motion data;
calculating the motion data according to the data type to obtain the motion type corresponding to the terminal device.

3. The method according to claim 2, wherein the calculating the motion data according to the data type to obtain the motion type corresponding to the terminal device comprises:
determining a rotation angle of the terminal device through angular velocity data, and determining the motion type corresponding to the terminal device according to the rotation angle, when the data type is the angular velocity data;
determining an acceleration slope corresponding to acceleration data, and determining the motion type corresponding to the terminal device according to the acceleration slope, when the data type is the acceleration data.

4. The method according to claim 3, wherein the determining a rotation angle of the terminal device through angular velocity data and determining the motion type corresponding to the terminal device according to the rotation angle comprises: calculating rotation angles of the terminal device in a rotation phase and a return phase according to the angular velocity data, and determining a jog type corresponding to the terminal device according to the rotation angles of the rotation phase and the return phase;
wherein the determining an acceleration slope corresponding to acceleration data and determining the motion type corresponding to the terminal device according to the acceleration slope comprises: determining an acceleration slope corresponding to two consecutive acceleration data, and determining a tap type corresponding to the terminal device according to the acceleration slope.

5. The method according to claim 3, wherein the determining a rotation angle of the terminal device through angular velocity data and determining the motion type corresponding to the terminal device according to the rotation angle comprises:
obtaining the angular velocity data corresponding to a first time period, wherein the angular velocity data comprises an angular velocity component and an angular velocity modulus value;
processing the angular velocity component and/or the angular velocity modulus value corresponding to the first time period to obtain a first rotation angle, when the angular velocity component and/or the angular velocity modulus value corresponding to the first time period exceeds a respective predetermined angular velocity threshold;
obtaining an angular velocity component corresponding to a second time period, and processing the angular velocity component corresponding to the second time period to obtain a second rotation angle, when the first rotation angle is within a predetermined angle range;
determining the motion type corresponding to the terminal device according to the first rotation angle and the second rotation angle.

6. The method according to claim 5, wherein the processing the angular velocity component and/or the angular velocity modulus value corresponding to the first time period to obtain a first rotation angle comprises:
determining a motion axis of a motion collection device in the terminal device;
performing Euler integration on the angular velocity component corresponding to the motion axis within the first time period, to obtain the first rotation angle.

7. The method according to claim 5, wherein the angular velocity data further comprises timestamp information, and after the processing the angular velocity component corresponding to the first time period to obtain the first rotation angle when the angular velocity component and/or the angular velocity modulus value corresponding to the first time period exceeds the predetermined angular velocity threshold, the method further comprises:
obtaining a first angular velocity component and a second angular velocity component within the first time period;
determining an angular velocity slope, according to the first angular velocity component and a timestamp information of the first angular velocity component, and the second angular velocity component and a timestamp information of the second angular velocity component;
obtaining the angular velocity component corresponding to the second time period, and processing the angular velocity component corresponding to the second time period to obtain the second rotation angle, when the first rotation angle is within the predetermined angle range and the angular velocity slope is greater than a predetermined angular velocity slope.

8. The method according to claim 5, wherein the determining the motion type corresponding to the terminal device according to the first rotation angle and the second rotation angle comprises:
determining a difference between the first rotation angle and the second rotation angle;
determining that the motion type corresponding to the terminal device is a jog type, when the difference between the first rotation angle and the second rotation angle is less than a predetermined angle threshold.

9. The method according to claim 8, wherein the determining the motion type corresponding to the terminal device according to the first rotation angle and the second rotation angle further comprises:
determining a motion axis of a motion collection device in the terminal device;
obtaining a motion direction of the motion axis; and
determining a jog type according to the motion axis and the motion direction of the motion axis.

10. The method according to claim 9, wherein different jog types are correspondingly set with different control information.

11. The method according to claim 3, wherein the determining an acceleration slope corresponding to the acceleration data and determining the motion type corresponding to the terminal device according to the acceleration slope comprises:
obtaining acceleration data corresponding to a plurality of moments, wherein the acceleration data comprises an acceleration component and an acceleration modulus value;
processing an acceleration component and/or an acceleration modulus value corresponding to a first moment and an adjacent moment to obtain a first acceleration slope, when the acceleration component and/or the acceleration modulus value corresponding to the first moment exceeds a respective predetermined acceleration threshold; and
determining that the motion type corresponding to the terminal device is a single tap, when the first acceleration slope exceeds a predetermined slope threshold.

12. The method according to claim 11, wherein after the determining that the motion type corresponding to the terminal device is the single tap when the acceleration slope exceeds the predetermined slope threshold, the method further comprises:
determining whether an acceleration component and an acceleration modulus value corresponding to a second moment exceeds the predetermined acceleration threshold;
processing the acceleration component and/or the acceleration modulus value corresponding to the second moment and its adjacent moment to obtain a second acceleration slope, when the acceleration component and/or the acceleration modulus value corresponding to the second moment exceeds the respective predetermined acceleration threshold;
determining a difference between the second moment and the first moment, when the second acceleration slope exceeds the predetermined slope threshold; and
determining that the motion type corresponding to the terminal device is a multiple tap, when the difference between the second moment and the first moment is less than a predetermined time threshold.

13. The method according to claim 3, wherein the angular velocity data comprises an angular velocity component and an angular velocity modulus value; the angular velocity component comprises three-axis angular velocity components; the angular velocity components comprise a first angular velocity component corresponding to x-axis, a second angular velocity component corresponding to y-axis, and a third angular velocity component corresponding to z-axis; the angular velocity modulus value is an absolute value calculated from the three-axis angular velocity components;
the acceleration data comprises an acceleration component and an acceleration modulus value; the acceleration component further comprises three-axis acceleration components; the three-axis acceleration components comprise a first acceleration component corresponding to x-axis, a second acceleration component corresponding to y-axis, and a third acceleration component corresponding to z-axis; the acceleration modulus value is an absolute value calculated from the three-axis acceleration components.

14. The method according to claim 13, wherein the three-axis angular velocity components is obtained through a gyroscope;
a first formula for calculating the angular velocity modulus value is:
$$\vert ω \vert = \sqrt{{( {ω}_{x} )}^{2} + {( {ω}_{y} )}^{2} + {( {ω}_{z} )}^{2}} ;$$
wherein |ω| is the angular velocity modulus value, ωₓ is the first angular velocity component corresponding to the x-axis, ω_{y} is the second angular velocity component corresponding to the y-axis, and ω_{z} is the third angular velocity component corresponding to the z-axis;
the three-axis acceleration components are obtained through an accelerometer;
a second formula for calculating the acceleration modulus value is:
$$\vert a \vert = \sqrt{{( {a}_{x} )}^{2} + {( {a}_{y} )}^{2} + {( {a}_{z} )}^{2}} ;$$
wherein |a| is the acceleration modulus value, aₓ is the first acceleration component corresponding to the x-axis, a_{y} is the second acceleration component corresponding to the y-axis, and a_{z} is the third acceleration component corresponding to the z-axis.

15. The method according to claim 1, wherein the obtaining control information corresponding to the extended screen according to the motion type of the terminal device comprises:
obtaining a mapping relationship between a predetermined motion type and the control information, and determining whether the motion type of the terminal device is the predetermined motion type; and
determining the control information corresponding to the motion type of the terminal device according to the mapping relationship, when the motion type of the terminal device is the predetermined motion type.

16. The method according to claim 1, wherein the control information comprises at least one of the following:
controlling the extended screen to execute an activation instruction;
controlling the extended screen to execute a selection instruction;
controlling the extended screen to execute a deactivation instruction;
controlling the extended screen to execute a switch instruction;
controlling the extended screen to execute a zoom-in instruction; and
controlling the extended screen to execute a zoom-out instruction.

17. The method according to claim 1, wherein the wearable device is configured to provide an extended screen for the terminal device, the wearable device comprising: a memory and a processor; the memory is connected to the processor and is configured to store a program, and the processor is configured to, by running the program stored in the memory, control an extended screen applied to the wearable device.

18. A method for controlling an extended screen, applied to a terminal device, the method comprising:
obtaining motion data collected by a motion collection device in the terminal device;
determining a motion type corresponding to the terminal device according to the motion data; and
sending the motion type to a wearable device, so that the wearable device determines control information corresponding to the extended screen according to the motion type and controls the extended screen according to the control information.

19. The method according to claim 18, wherein an extended screen of the terminal device is provided by a wearable device, the terminal device comprising: a memory and a processor; the memory is connected to the processor and is configured to store a program, and the processor is configured to, by running the program stored in the memory, implement the method for controlling an extended screen applied to a terminal device.

20. A non-transitory computer-readable storage medium, wherein the computer-readable storage medium stores a computer program, and when the computer program is executed by a processor, the processor implements the method for controlling an extended screen applied to a wearable device according to claim 1.
